(19) United States
(12) Patent Application Publication
(10) Pub. No.: US 2004/0215764 A1
(43) Pub. Date: Oct. 28, 2004

(54) Method, system, and program for rendering a visualization of aggregations of network devices

(75) Inventors: Jeffrey W. Allen, Denver, CO (US); Jeffrey Lawrence Sokolov, Lexington, MA (US); Brian D. Ehret, San Mateo, CA (US)

Correspondence Address: KUDIRKA & JOBSE, LLP, ONE STATE STREET, SUITE 800, BOSTON, MA, 02109, US

(73) Assignee: Sun Microsystems, Inc.

(21) Appl. No.: 10/422,444

(22) Filed: Apr. 23, 2003

(51) Int. Cl. G06F 15/173

(52) U.S. Cl. 709/224; 709/223

(57) ABSTRACT

Provided are an article of manufacture, method and system for rendering a visualization of a network of devices. Aggregate device representations are rendered, wherein at least one aggregate device representation provides a single representation for a plurality of the devices. Single device representations for the devices not represented by the at least one aggregate device representation are rendered. Connection representations of connections between rendered representations of the devices in the network are rendered.

### BACKGROUND OF THE INVENTION

1. Field of the Invention

The present invention relates to a method, system, and program for rendering a visualization of aggregations of network devices.

2. Description of the Related Art

A storage area network (SAN) comprises a network linking one or more servers to one or more storage systems. Each storage system could comprise a Redundant Array of Independent Disks (RAID) array, tape backup, tape library, CD-ROM library, or JBOD (Just a Bunch of Disks) components. One common protocol for enabling communication among the various SAN devices is the Fibre Channel protocol, which uses optical fibers or copper wires to connect devices and provide high bandwidth communication between the devices. The Fibre Channel protocol defines a fabric topology. A fabric includes one or more interconnected switches, each switch having multiple ports. A fiber link may connect ports on a device to ports on a switch, where a device connected to a switch in a fabric can communicate with all other ports attached to any switch in the fabric.

During SAN operations, information on various devices in one or more fabrics in a SAN may be gathered. The information may concern devices from different vendors. There is a need in the art for improved techniques for managing information gathered on the different components in a SAN and providing a visualization of the network topology.

### SUMMARY OF THE DESCRIBED IMPLEMENTATIONS

Provided are an article of manufacture, method and system for rendering a visualization of a network of devices. Aggregate device representations are rendered, wherein at least one aggregate device representation provides a single representation for a plurality of the devices. Single device representations for the devices not represented by the at least one aggregate device representation are rendered. Connection representations of connections between rendered representations of the devices in the network are rendered.

In further implementations rendering connection representations further comprises rendering connection representations between single device representations representing connected devices and rendering connection representations for aggregate device representations representing at least one device connected to another device.

In further implementations, rendering connection representations for aggregate device representations further comprises rendering connection representations between aggregate device representations, wherein the aggregate device representation at a first end of the connection representation represents at least one device connected to at least one device represented by the aggregate device representation at a second end of the connection representation.

Still further, the aggregate device representations may represent a plurality of aggregate device representations.

In yet further implementations, a selection is made of one aggregate device representation and, in response to receiving the selection, a representation of each aggregate device representation and single device represented by the selected aggregate device representation is rendered.

Still further, a status representation for each aggregate device representation may be rendered, wherein the status representation comprises a status associated with at least one device represented by the aggregate device representation.

The described implementations of the invention provide techniques for displaying a network topology of network devices and the connections therebetween. The described implementations allow the visualization of numerous devices and connections in a manner that may be readily observed and comprehended by users viewing the user interface rendering the visualization of the network topology.

### BRIEF DESCRIPTION OF THE DRAWINGS

Referring now to the drawings in which like reference numbers represent corresponding parts throughout:

FIG. 1 illustrates an arrangement of network components in a manner known in the art;

FIG. 2 illustrates program components in a network management application in accordance with implementations of the invention;

FIG. 3 illustrates an example of output generated from information maintained in the objects providing information on network components in accordance with implementations of the invention;

FIGS. 4, 5, and 6 illustrate user interface panels displayed to enable a user to render images representing connections between a selected host and storage components in accordance with implementations of the invention;

FIGS. 7 and 8 illustrate examples of a network topology in accordance with implementations of the invention;

FIGS. 9-12 illustrate examples of user interfaces displaying information on network devices and connections therebetween in accordance with implementations of the invention;

FIG. 13 illustrates logic to generate a visualization of a network topology in accordance with implementations of the invention;

FIGS. 14-19 illustrate examples of user interfaces displaying information on network devices, aggregate device representations, and connections therebetween in accordance with implementations of the invention;

FIG. 20 illustrates a data structure providing information on an aggregate device representation;

FIG. 21 illustrates logic to generate a visualization of a network topology including aggregate device representations in accordance with implementations of the invention;

FIG. 22 illustrates an additional implementation of program components in a network management application in accordance with implementations of the invention; and

FIG. 23 illustrates a computer architecture that may be used to implement network devices, such as the SAN manager system, hosts, storages, switches, etc.

### DETAILED DESCRIPTION

In the following description, reference is made to the accompanying drawings which form a part hereof and which illustrate several embodiments of the present invention. It is understood that other embodiments may be utilized and structural and operational changes may be made without departing from the scope of the present invention.

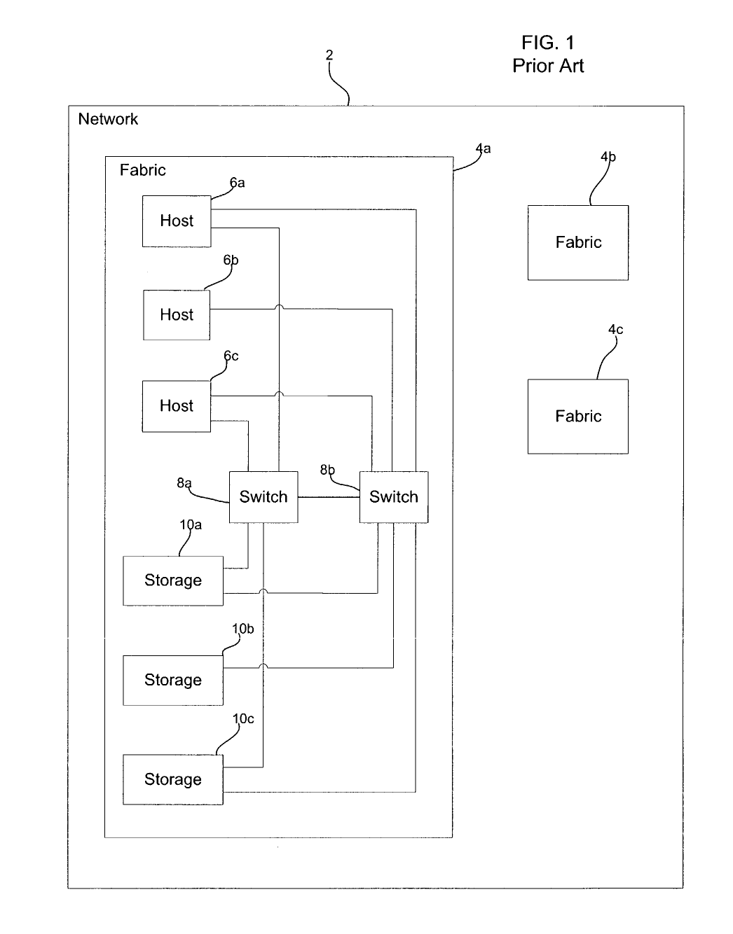

FIG. 1 illustrates an example of a network 2, such as a SAN, comprised of multiple fabrics 4a, 4b, 4c, where each fabric includes multiple interconnected devices, also referred to as components, such that the switches in one fabric do not connect to any of the devices in another fabric. As shown in fabric 4a, a fabric includes hosts 6a, 6b, 6c, switches 8a, 8b, and storages 10a, 10b, 10c, where each device in the fabric is connected to one or more other devices in the fabric. The hosts 6a, 6b, 6c, switches 8a, 8b, and storages 10a, 10b, 10c would further each include one or more ports (not shown) to provide one or more connections with another component. The hosts 6a, 6b, 6c include host bus adaptor (HBA) cards (not shown) that include the host ports to connect to various devices, such as switch ports, etc. Further switch 8a, 8b ports may be included in zones, such that any device attached to a switch port in one particular zone can only communicate with devices attached to switch ports in the same zone. Still further, a host may include multiple ports and have different ports connected to different switches, where the switches are not in any way interconnected. In such an arrangement, the host connected to such switches that are not connected is connected to different fabrics. The switches 8a, 8b may be connected via an interswitch link, such as shown in FIG. 1, or not connected.

The hosts 6a, 6b, 6c may comprise any computing device known in the art, such as a server class machine, workstation, storage host, host cluster, etc., having adaptor cards with ports to connect to one switch port in switches 8a, 8b. The switches 8a, 8b may each include multiple switch ports to interconnect different devices in a fabric, wherein the devices may be connected in a network, such as a SAN, Local Area Network (LAN), Wide Area Network (WAN), etc. The storages 10a, 10b, 10c may comprise any storage system known in the art which has compatible ports, such as a storage array, e.g., a storage subsystem, a subsystem cluster, Just a Bunch of Disks (JBOD), Redundant Array of Independent Disks (RAID), Direct Access Storage Device (DASD), etc., tape drive, tape library, disk drive, optical disk drive, virtualization device, etc. The ports within the hosts 6a, 6b, 6c and storages 10a, 10b, 10c may comprise NxPorts, or any other ports known in the art. The network 2 or SAN may further include direct attached storage (DAS) devices that connect directly to another host or device other than a switch and orphan devices not connected to any other component.

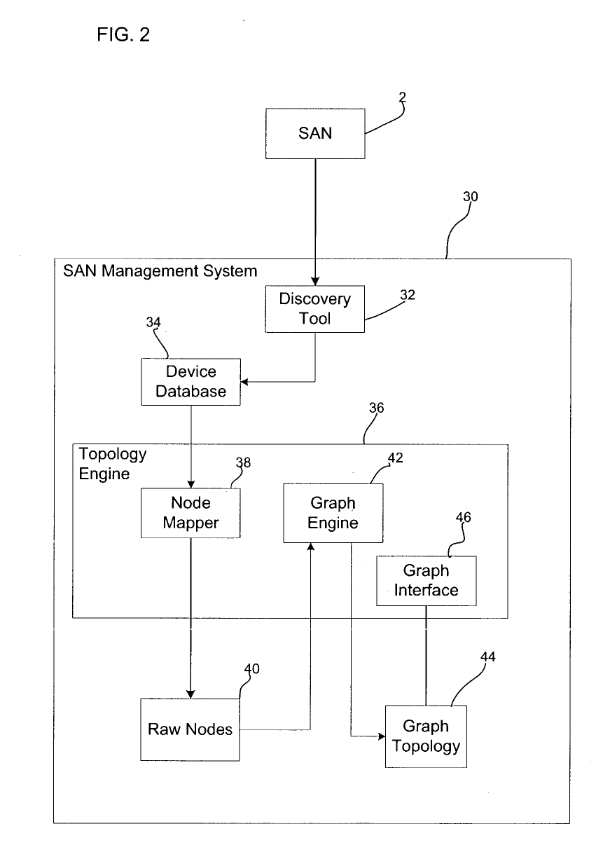

FIG. 2 illustrates a SAN management system 30 used by a network administrator, where the system 30 may be coupled to the SAN 2 or implemented in a SAN component. The SAN management system 30 includes a discovery tool 32 program that mines device information from the SAN 2 and populates a device database 34 with the mined information that stores information on each of the components of the SAN 2, where a component comprises a logical or physical device, e.g., hosts 6a, 6b, 6c, switches 8a, 8b, storages 10a, 10b, 10c, adaptors with the devices, ports, logical storage, zones, fabrics, etc. In certain implementations, the device database 34 may comprise a SAN domain model device information database. Thus, each component discovered by the discovery tool 32 may contain additional discovered components. For instance a discovered host 6a, 6b, 6c may include a discovered host bus adaptor (HBA), and the discovered HBA may include discovered ports; a discovered zone component may include device components and subcomponents; a discovered fabric may include numerous discoverable devices and subcomponents thereof. The discovery tool 32 may comprise multiple programs, tools or Application Programming Interfaces (APIs) provided by different device vendors whose devices are included in the SAN 2. Alternatively, the discovery tool 32 may access information from devices implementing the Common Information Model (CIM) protocol to exchange device information. However, those skilled in the art will appreciate that any device management interface may be used to access device information from the SAN components. The device database 34 stores the discovered device data.

A topology engine program 36 includes program components 38, 42, and 46 to process the device information in the device database 34. The topology engine 36 includes a node mapper 38 program that transforms the data in the device database 34, that may be gathered by discovery tools from different vendors, into a plurality of raw nodes 40 in a common format, where each raw node maintains various device information. A graph engine 42 program processes the raw nodes 40 and generates a graph topology 44 including graph nodes providing interrelated data structures that store the device information. The graph topology 44 provides information on each network device and its connection to other network devices and the zones in which devices are included, i.e., the topology of the network 2. A graph interface 46 provides methods, such as program functions and/or graphical user interface (GUI) controls, to allow a user to traverse the graph topology 44 to access information on the connection and arrangement of devices in the SAN 2 and render graphical representations of the SAN components and their physical and logical interrelationship. In alternative implementations, the program components 38, 42, and 46 of the topology engine 36 may comprise separate applications, or some of the components 38, 42, and 46 may be external to the topology engine 36. The copending and commonly assigned patent application entitled “Method, System, and Program for Rendering a Visualization of Network Devices,” having U.S. application Ser. No. 10/290,868 and filed on Nov. 8, 2002, which patent application is incorporated herein by reference in its entirety, provides further detail on how the graph topology 44 may be generated.

After the graph topology 44 is generated, the content of the topology may be stored in a database or any other file or data structure in a computer readable medium. The graph topology 44 content may be refreshed whenever any change to the device database 34 (FIG. 2) is detected indicating a possible change to the SAN 2 architecture. Such a modification would trigger the node mapper 38 to regenerate the raw nodes 40, which are then provided to the graph engine 42 to process and generate the graph topology 44.

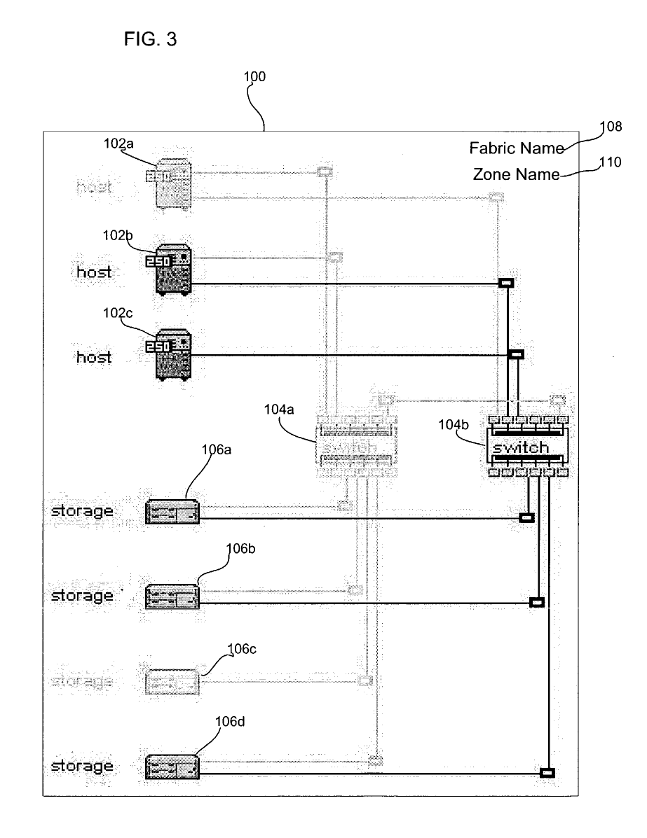

The graph interface 46 may provide a set of interfaces, such as methods or user interface controls, that allow a user to access information from any of the objects, or transfer the topology objects to obtain information on any components contained within the component represented by a particular object. For instance, FIG. 3 illustrates rendered output 100, which may be rendered on a display device or tangible medium, such as paper, that is generated by running a program that seeks to access all SAN components within a selected zone of a particular fabric, where the components in the selected zone, including switch 104b and attached hosts 102b, 102c and storage 106a, 106b, 106d, are shown darker than the components in zones other than the selected zone, including switch 104a and attached hosts 102a and storage 106c. FIG. 3 further displays a fabric name 108 in which the displayed components are included and a zone name 110 indicating the zone that is displayed. FIG. 3 represents the zone having the zone name 110 by displaying those components in the zone in a darker color than components not within the zone having the zone name 110. In certain implementations, within a single fabric zone names must be unique, but the same zone name can be used in different fabrics. In the output 100 in FIG. 3, the components 102b, 102c, switch 104b, and storage 106a, 106b, 106d within the selected zone are rendered in a different manner than the components 102a, 104a, 106c outside of the selected zone. Alternatively, if no zone was selected when the graph interface 42 was invoked, then all the host, switch, and storage components in the selected fabric would be rendered in the same manner, without zone distinctions.

In additional implementations, the graph interface 46 may include GUI panels, such as a user interface wizard, to allow a user to select a host 6a, 6b, 6c (FIG. 1) and storage 10a, 10b, 10c in the SAN 2, and then automatically show all switches that connect, either directly or indirectly, to the selected host and storage. This allows the user or SAN administrator to determine whether the selected SAN components are physically and logically connected. Further, by displaying information on all switches connected to each selected component, the administrator can determine which connections to add between a switch connected, directly or indirectly (i.e., through cascading) to one selected component and the other component or a switch to which the other component is connected. Further implementations display zone information to allow the administrator to determine whether the assignment of switch ports to zones needs to be altered to provide a connection between the selected host and storage.

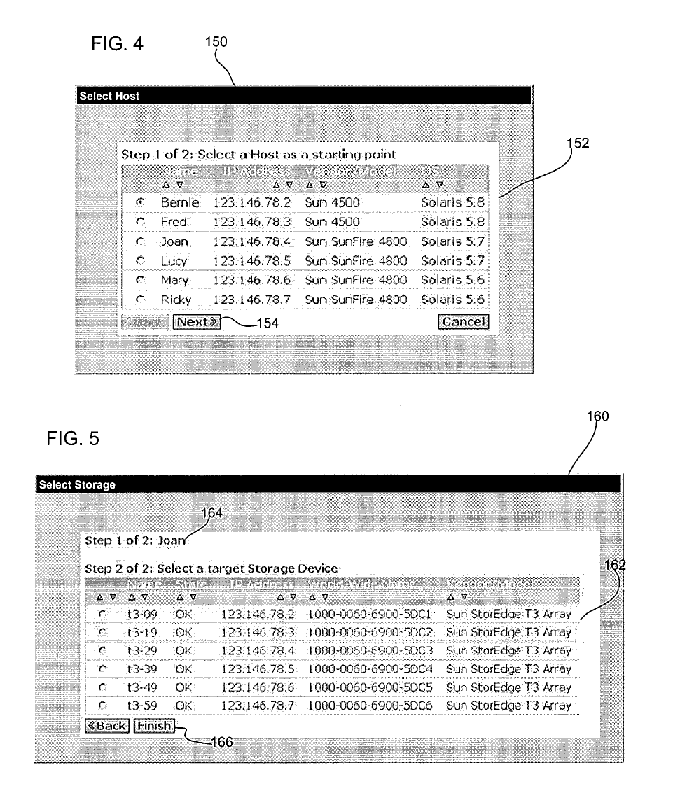

FIGS. 4, 5, and 6 illustrate the GUI panels presented to the user to gather information on selected devices and then display the switches directly and indirectly connected to the user selected devices. FIG. 4 illustrates a GUI panel 150 that the graph interface 46 renders in a display monitor attached to the SAN management system 30 (FIG. 2) that displays a list 152 of all the hosts 6a, 6b, 6c (FIG. 1) in the SAN 2. Alternatively, the user may manually enter the name of a host to select. Upon selecting the “Next” button 154, the graph interface 46 displays GUI panel 160 shown in FIG. 5 that displays a list 162 of storages 10a, 10b, 10c (FIG. 1) from which the user may select. The panel 160 further displays the name of the host 164 the user selected in the previous panel 150. Selection of the “Next” button 166 would cause the graph interface 46 to display the topology showing all switches directly and indirectly connected to the selected host and storage.

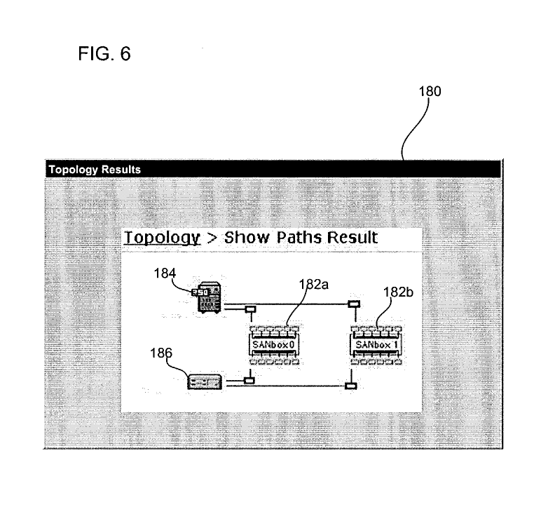

FIG. 6 illustrates an example of a GUI panel 180 showing the switches 182a, 182b to which the selected host 184 and selected storage 186 are attached. In the topology shown in FIG. 5, both selected host and storage are connected directly to the same switches.

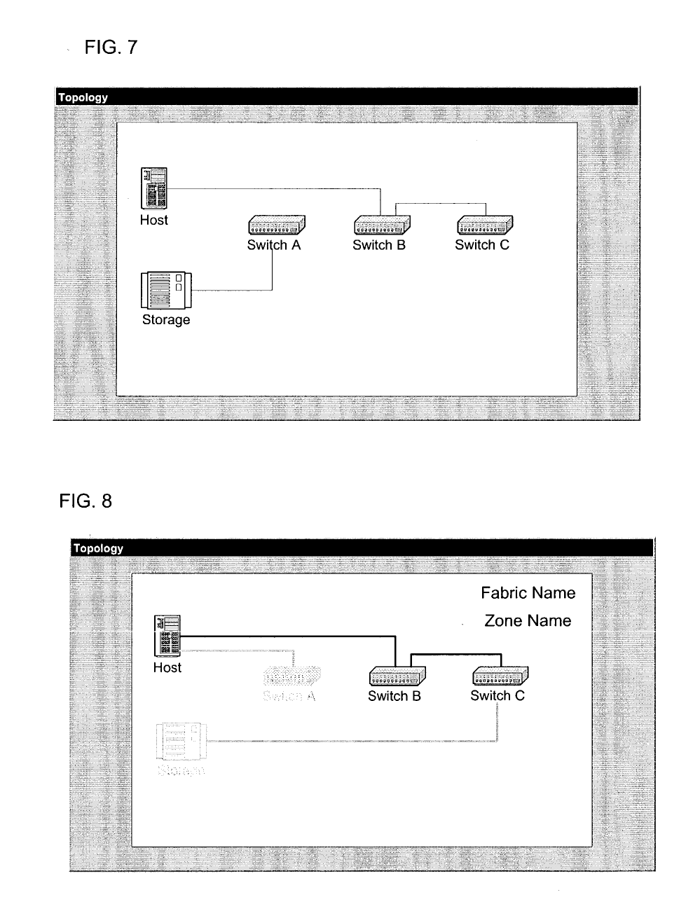

FIG. 7 illustrates an example of a topology visualization having all switches to which a selected host and storage connect, both indirectly or directly. The topology shown in FIG. 7 may indicate that all the connected paths and switches are in zone(s) accessible to the host because they are rendered in the same manner, e.g., with the same degree of boldness. FIG. 8 illustrates a further example where some of the connected switches and path to the selected host are displayed in a different manner than other paths connected to the host, indicating that switch A and the selected storage are in zones inaccessible to the host, whereas the switch ports in switches B and C that connect to the host are in the same zone as the host, whereas the storage connects on a path to a switch port in switch C that is in a zone inaccessible to the host. Those paths and devices in zones not accessible to the host are rendered in a lighter shade than those paths and components in zones accessible to the host. The rendered connections may further indicate the fabric name and zone name including the rendered components. Although devices not included in the same zone as the host may be displayed in a different manner (such as greyed out) or not displayed at all, such devices not in the zone may nonetheless be connected to the devices displayed within the zone. However, although such out-of-zone devices may be connected to the in-zone devices being displayed, they are rendered in a different manner or not rendered at all for the zone topology view.

In further implementations, the user may select multiple hosts and storage in the GUI panels to render switches connected to all the selected hosts and storages.

The above described user interfaces for rendering a view of all switches connected to a selected host and storage allow the user to easily determine how to provide further connection paths between the host and storage. For instance, the user can determine that if no path provides a common connection, then a connection can be made from one device to a switch having switch ports to which the other device connects. Alternatively, if the devices share a common switch, but the selected host and storage are in different zones as shown in FIG. 8, then the user can decide to reconfigure the switch ports connecting the devices to the common switch to be in the same zone to provide a path between the selected host and storage. The above topology may further be used for failure analysis to determine whether there is no single point of failure in the connections between a selected host and storage. If there is no single point of failure, then the administrator may add additional switches or connections from the selected host and/or storage to the existing switches to enhance the availability of the selected host and storage.

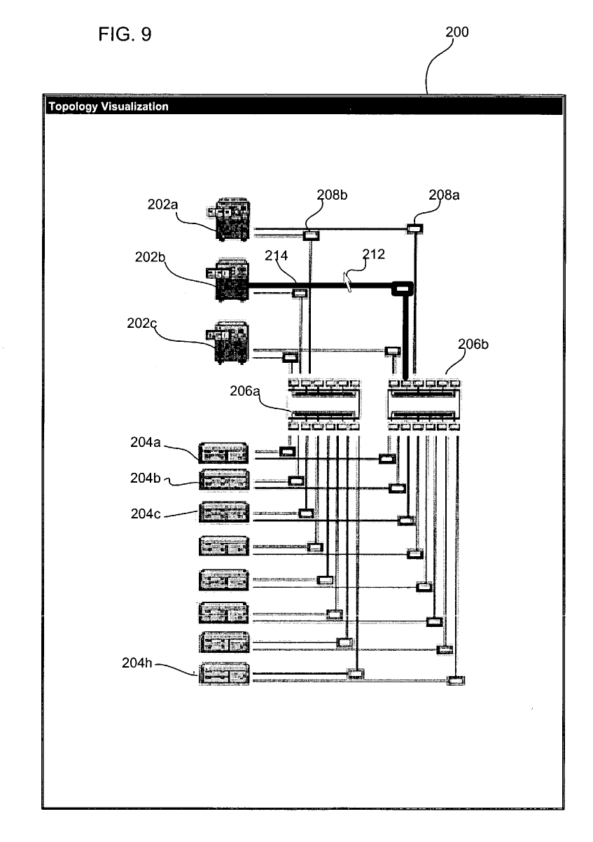

Further implementations of visualizations of alternative topological views of network components are shown in FIGS. 9-12, where the topological information, such as information on hosts, storage devices, switches, and the connections therebetween may be generated according to techniques described in the copending and commonly assigned patent application entitled “Method, System, and Program for Rendering a Visualization of Network Devices,” having U.S. application Ser. No. 10/290,868, which application was incorporated herein by reference in its entirety above.

FIG. 9 illustrates one implementation of a visualization of a topology view. A rendered user interface window 200 displays representations of host systems 202a, 202b, and 202c and storage devices 204a, 204b . . . 204h, and their connections to switches 206a and 206b. In the implementation of FIG. 9, the lines connecting the hosts 202a, 202b, 202c and storage devices 204a, 204b . . . 204h to the switches 206a and 206b form approximately ninety degree angles and status boxes 208a, 208b, etc., providing status information on a connection are displayed at the ninety degree angle. As shown in FIG. 9, the status boxes 208a, 208b may be located at the juncture of the two lines extending from the connected devices that form a 90 degree angle. The status boxes can also be located at positions on the lines connecting the devices other than the juncture of the 90 degree angle. In alternative implementations, the lines connecting the devices may have an angle different than ninety degrees, or comprise a single bent line. Further, different lines may have different angles to improve the visualization of the topology. In certain implementations, the status boxes 208a, 208b may visualize a status of the connection between the host/storage device and switch connected by the line including the status box. The status box may display one color and/or pattern to indicate that the status is operational and that there are no errors in the connection and display one or more other colors and/or patterns to indicate one or more error states with respect to the connection. The use of the ninety degree angled lines to connect two devices conserves space and allows lines to be positioned closer together when there are numerous connected devices. Further, having lines connect at an approximate ninety degree angle at two orientations (one horizontal and the other vertical) makes it easier for the human eye to track the connections, thereby minimizing the chance of human error in visualizing the connections between the displayed renderings. Further, lines could be drawn between the switches 206a and 206b representing one or more connections between two switches.

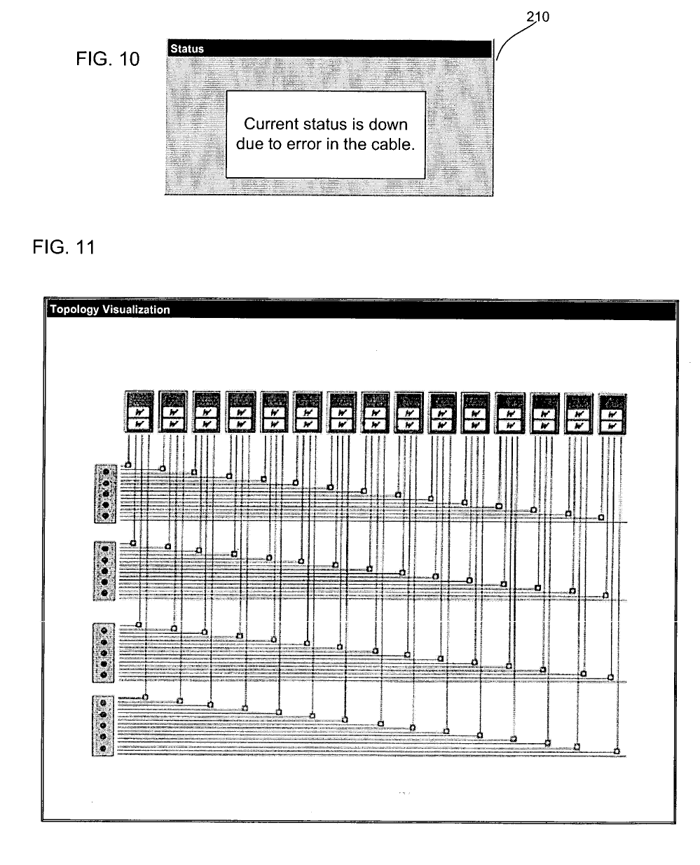

The status boxes 208a, 208b may be programmed to display further information on the connection and/or operational/error status in response to user selection of the status box. FIG. 10 illustrates how the status information may be displayed in a separate graphical comment box 210. This graphical comment box may be displayed over the topological view 200. The status information may describe the current status, down, active, etc., and information on the error or problem component in the device. The status information rendered in the comment window or dialog box 210 may comprise text and/or visual representations of the connections between the devices connected on the line where the selected status box 208a, 208b is located.

In further implementations, when passing a user pointing device, such as mouse, electronic pen, etc., over a line rendered in the user interface 200, the line and/or devices attached thereto may be displayed in a more prominent and different manner than the lines illustrating different connections between different devices. Further, the entire row and column representing the connection between the selected devices or connection may be highlighted to direct a user line of vision to the connection between the devices. FIG. 9 illustrates how when a mouse pointer 212 is positioned over a line 214, that connection line 214 is displayed in a different and more striking manner than the other lines representing connections between devices. Further, the devices connected by the line may also be displayed in a different manner to highlight the devices connected by the selected line. Still further, selection of a device would display the line and device to which the selected device connects.

FIG. 11 provides a further example of a user interface implementation where the lines connecting devices form a ninety degree angle. FIG. 11 illustrates how numerous devices and the connections therebetween can be accommodated and visualized using lines having a ninety degree angle with status boxes at the ninety degree angle. In alternative implementations, the status boxes may be displayed at different locations on the connection lines.

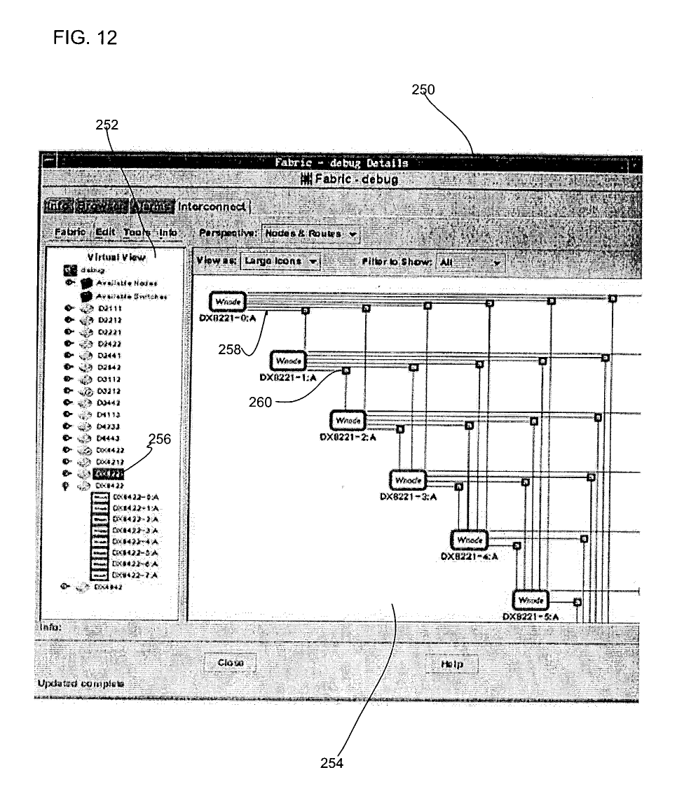

FIG. 12 illustrates a user interface 250 implementation where the user selects a device in a device selection panel 252 and the right panel 254 displays all connections between the device selected in panel 252, which is device 256, and devices to which the selected device connects, where the lines, e.g., line 254 illustrating the connections between any two devices form right angles. Further, at each right angle a status box, e.g., status box 260, is rendered to visualize status information on a connection in the manner described above with respect to FIG. 10. FIG. 12 illustrates the use of the implementation showing the lines as forming right angles. Alternatively, the right panel may show a visualization of all devices, such as shown in FIG. 11, with the selected device and all devices connected thereto visualized in a highlighted and offset manner to show what is selected. In further implementations, selection of any shape or rendering representing a device or connection may display information on that device or connection and status information thereof.

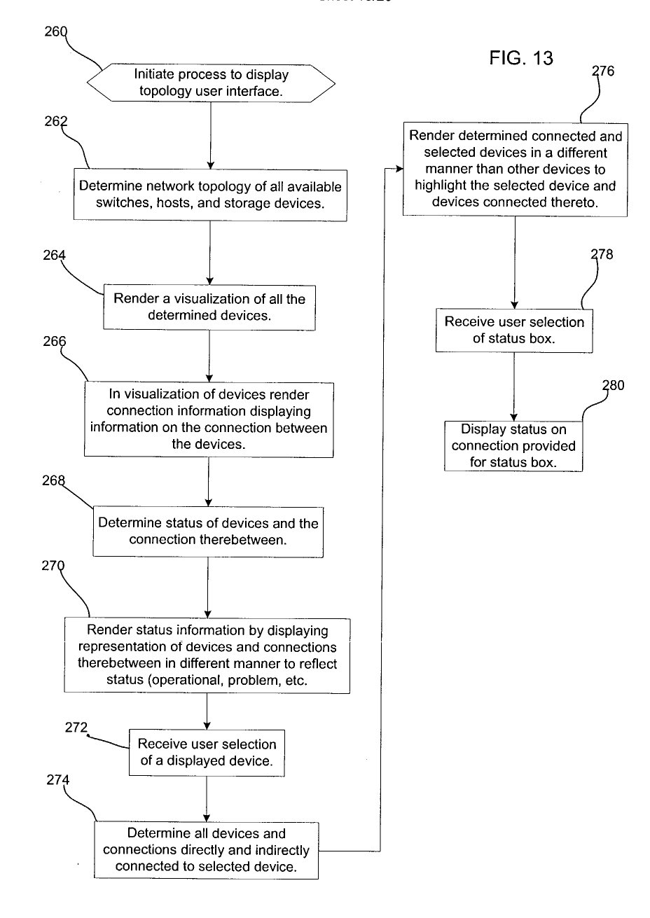

FIG. 13 illustrates logic implemented in the topology engine 36 (FIG. 2) to generate a topology user interface. Control begins at block 260 to initiate the process to generate a topology user interface providing a visualization of the network devices and their connections. The topology engine 36 determines (at block 262) the network topology, including all available hosts, storage devices, switches and connections therebetween. The topology engine may utilize the logic described in the copending and commonly assigned patent application entitled “Method, System, and Program for Rendering a Visualization of Network Devices,” having U.S. application Ser. No. 10/290,868, which application was incorporated herein by reference in its entirety above, to determine the network topology. The topology engine then renders (at block 264) a visualization representation of all the determined devices, e.g., storage devices, switches, and hosts, in the user interface. The determined devices may be visualized in the manner described with respect to FIGS. 7-9 and 11, where any shape, image, color and/or pattern may be used to represent a device in the user interface. The topology engine 36 would further render (at block 266) a representation of all the connections between the devices, which may be visualized in the manner described with respect to FIGS. 7-9 and 11 as a line, straight or forming a ninety degree angle. The status of all the devices and connections therebetween would be determined (at block 268) and a visualization of the status may be rendered (at block 270) as described with respect to FIGS. 7-9 and 11, which may involve displaying the representations of the devices in different colors and/or patterns, or displaying a status box, such as the status boxes 208a, 208b shown in FIG. 9.

In response to receiving user selection (at block 272) of one device or connection, the topology engine would determine (at block 274) all devices and connections that are indirectly and/or directly connected to the selected device or connection. In certain implementations, information on the indirect or direct connections may be determined according to the logic described in the copending and commonly assigned patent application entitled “Method, System, and Program for Rendering a Visualization of Network Devices,” having U.S. application Ser. No. 10/290,868, which patent application was incorporated herein above by reference in its entirety. The topology engine 36 may then render (at block 276) a visualization of all the determined connected and selected devices in a different manner than other devices to highlight the selected device and devices and connections directly and indirectly connected thereto. Examples of a highlighted selected device and connected devices and connections are illustrated in FIG. 9. In response to receiving (at block 278) user selection of a rendered status of a device, such as user selection of a status box 208a, 208b (FIG. 9), the status information related to the selected status visualization would be rendered (at block 280), such as the status box 210 (FIG. 10) rendering status information concerning a connection.

In certain situations, the network topology may include numerous instances of a certain device, such as numerous hosts, switches or storage devices. In such cases, it may not be feasible to display all such components in a single user interface window. Further implementations provide techniques to allow multiple devices to be aggregated in groups, where a single representation of the aggregation is used to represent all the devices included in an aggregation group.

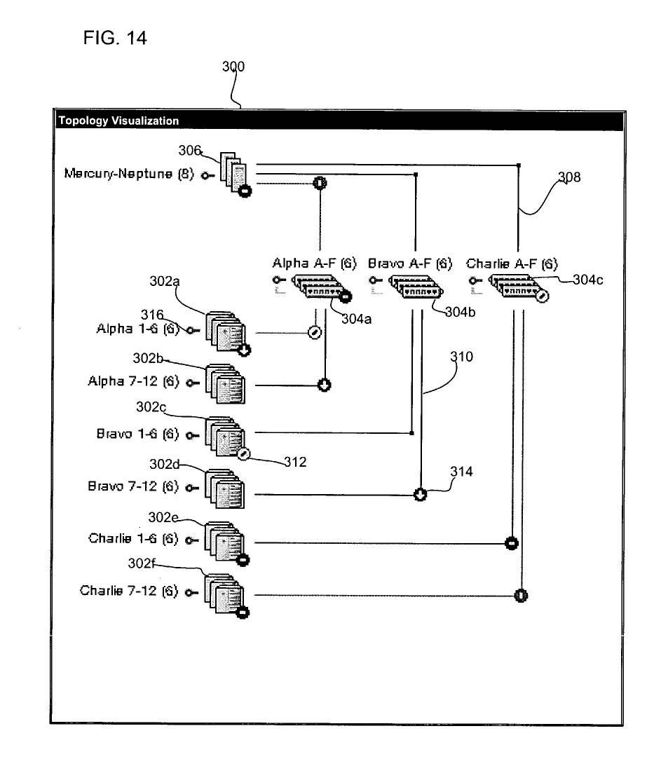

FIG. 14 illustrates a user interface implementation 300 showing aggregate device representations, where each aggregate device representation provides a non-overlapping grouping of specific network devices. For instance, aggregate storage representations 302a, 302b . . . 302f each represent a plurality of grouped storage devices; aggregate switch representations 304a, 304b, 304c each represent a plurality of grouped switches; and aggregate host representation 306, which represents a plurality of grouped host systems. Each aggregate device representation may be rendered as three cascading icons of a same device type, e.g., storage, host, switch. In alternative implementations, different graphical representations may be used to represent the device aggregations. Each path, e.g., paths 308, 310, represent a connection between aggregate devices. A rendered path 308, 310 between a connected aggregate device and another device, which may be an aggregate device representation or a single device representation that represents a single instance of a device, represents all connections from the devices grouped within the aggregate device representation and the connected single device or one device of an aggregate if the path connects to an aggregate device representation. Thus, each rendered path 308, 310 between one aggregate device representation and another single or aggregate representation may represent one or more paths from the multiple devices grouped in the aggregate device representation. For instance, the path 308 indicates that at least one of the hosts grouped in the rendered aggregate host representation 306 is connected to at least one of the switches grouped in the rendered aggregate switch representation 304c. Similarly, the path 310 indicates that at least one of the storage devices grouped in the rendered aggregate storage representation 302d is connected to at least one of the switches grouped in the rendered aggregate switch representation 304b.

The user interface 300 may also display status indicators associated with a device or a path between devices. For instance, status indicator 312 indicates a state of at least one of the storage devices grouped in the aggregate storage representation 302c. The status indicator may include a marking and/or color to indicate a status representing a state of an error at the device, e.g., minor, major, critical, etc. If there is status associated with multiple devices grouped within a rendered aggregate device representation, then the most severe or troublesome status of the statuses for the grouped devices is displayed. For instance, if one device grouped with a rendered aggregate device representation has a severe status and another grouped device has a minor status error, then the representation of the severe error status will be rendered with the rendered aggregate device representation. A status indicator 314 may also be rendered with respect to the displayed paths indicating a status of one or more paths rendered between one aggregate device representation and one other connected single or aggregate device representation on the path.

FIG. 14 further illustrates an open indicator, such as key icon 316, indicating whether an aggregate device representation has been expanded to show single device representations or aggregate device representations grouped within the expanded aggregate device representation. In FIG. 14, displaying the open indicator 316 with a horizontal orientation indicates that the corresponding aggregate storage representation 302a is not expanded such that there are no single device or aggregate representations being rendered in the user interface 300. Still further, in FIG. 14 the name of the aggregate representations are displayed. Next to each name, the number of devices or aggregation of devices represented by the aggregation representation are displayed in parenthesis.

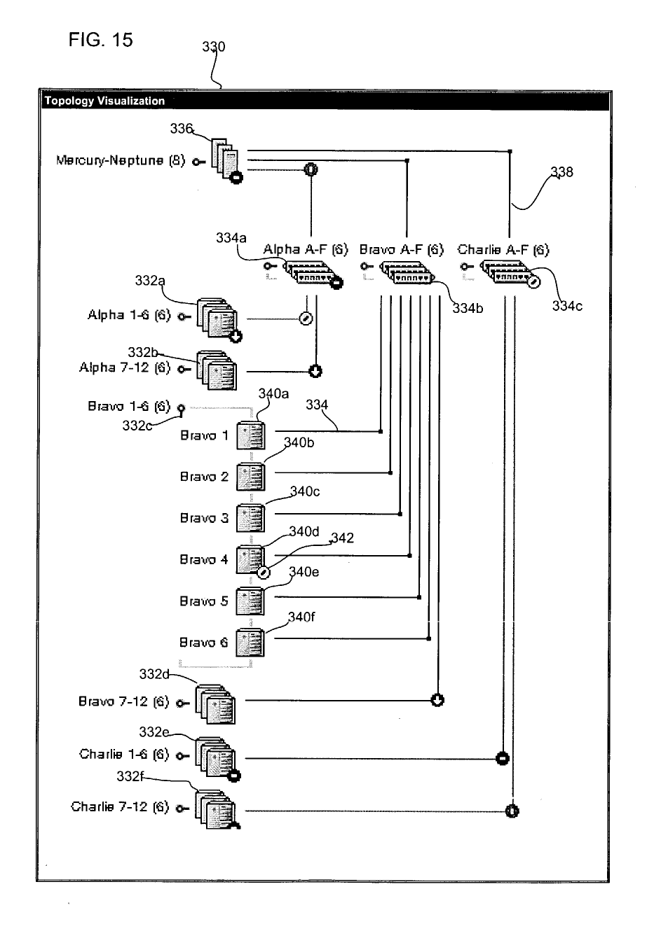

FIG. 15 illustrates an implementation of a user interface 330 that the graph engine 42 would render in response to user selection of the aggregate storage representation 302c to cause the display of all the components included in the aggregation of devices represented by 302c. In FIG. 15, the displayed aggregate host representation 336, aggregate storage representations 332a, 332b . . . 332f, and aggregate switch representations 334a, 334b, 334c represent the same devices represented by the aggregate host 306, storage 302a, 302b . . . 302f, and switch 304a, 304b . . . 304c representations rendered in FIG. 14. As shown in FIG. 15, all the components included in the aggregate storage representation 302c comprise single storage devices, e.g., storages 10a, 10b, 10c (FIG. 1), represented by the single storage device representations 340a, 340b . . . 340f. The user interface 330 illustrates a status indicator 342 associated with storage device representation 340d, which is the same status indicator 312 (FIG. 14) shown in user interface 300 (FIG. 14) associated with the aggregate storage representation 302c. Expanding the aggregate storage representation 302c further causes the display of all the paths, e.g., path 344, between the expanded single storage device representations 340a, 340b ...340f and the aggregate switch representation 334b comprising one or more switches to which the storage devices 340a, 340b . . . 340f connect.

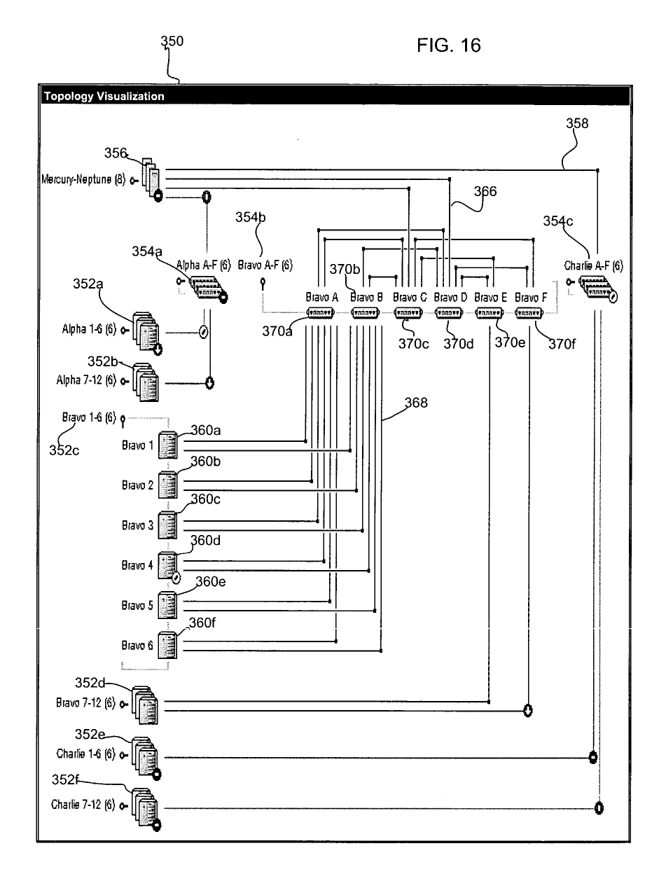

FIG. 16 illustrates an implementation of a user interface 350 that the graph engine 36 would render in response to user selection of the aggregate switch representation 334b in the user interface 330 of FIG. 15 to cause the display of all the switch components included in the aggregate switch representation 334b. In FIG. 16, the displayed aggregate host representation 356, aggregate storage representations 352a, 352b . . . 352f, single storage representations 360a, 360b . . . 360f, and aggregate switch representations 354a, 354b, 354c represent the same devices represented by the aggregate host 336, aggregate storage 332a, 332b . . . 332f, single storage device 340a, 340b . . . 340f, and switch 334a, 334b . . . 334c representations rendered in FIG. 15. As shown in FIG. 16, all the components included in the aggregate switch representation 354b comprise single switch devices, e.g., switches 8a, 8b (FIG. 1), represented by the single switch device representations 370a, 370b . . . 370f. Expanding the aggregate switch representation 334b further causes the display of all the paths, e.g., path 366, between the expanded single switch device representations 370a, 370b . . . 370f and the aggregate host representation 356 comprising one or more hosts to which the switches represented by 370a, 370b . . . 370f connect. Further, paths, e.g., 368, are also displayed between the expanded switch device representations 370a, 370b . . . 370f and the single storage devices 360a, 360b . . . 360f, which were previously expanded in user interface 330.

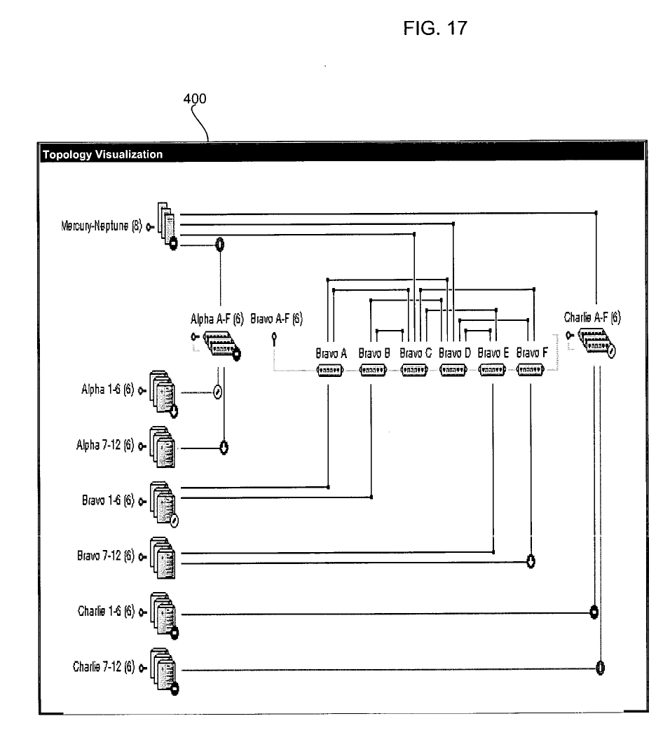

FIG. 17 illustrates a user interface 400 displayed upon selection of the aggregate switch representation 304b in user interface 300 (FIG. 13) to expand the aggregate switch representation 304b to display single switch devices Bravo A, B, C, D, E, F included in the aggregation. Paths between the expanded Bravo switch devices and the aggregate storage devices, representing a connection between one of the storage devices included in the aggregate storage devices and the expanded Bravo switch devices.

Any aggregate device representation may include not only individual devices, such as shown in FIGS. 16 and 17, but may include further aggregate device representations, such that aggregate device representations may be nested within another aggregate device representations, and displayed in the same manner described above with the first level aggregate device representations. If aggregate device representations are nested within each other, then the user may continue selecting aggregate device representations to drill down to a further lower level that includes another aggregate device representation or the actual device.

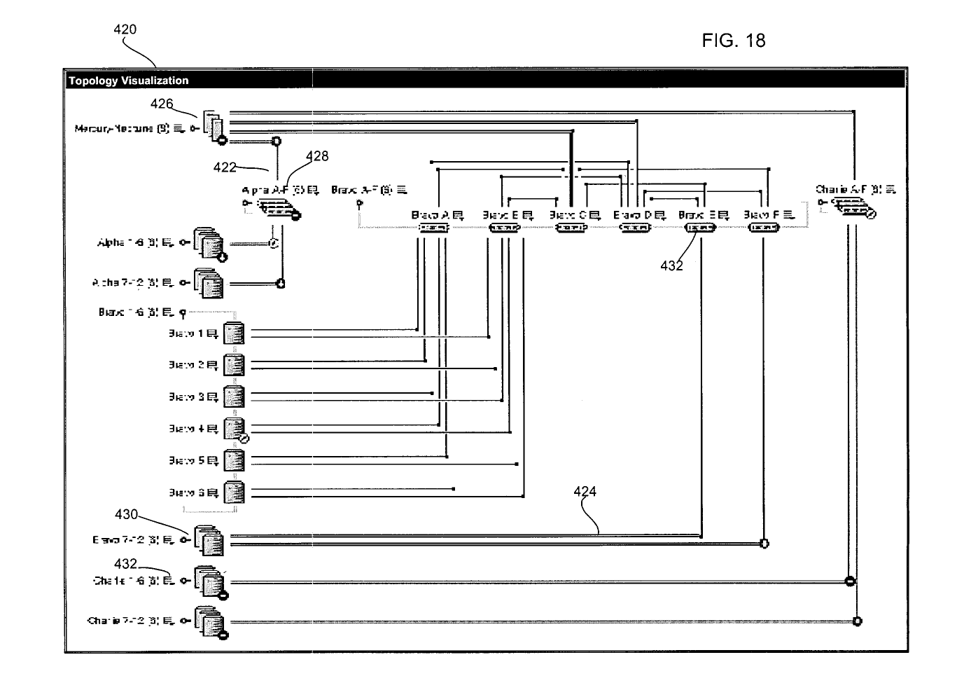

FIG. 18 illustrates an alternative implementation of FIG. 16 where the user interface 420 displays paths, e.g., paths 422, 424, with double lines to indicate that at least one devices included within an aggregate device representation has one or more paths to a device represented by a single device or aggregate device representation. Additionally, all connections between aggregate device representations can be represented with two lines, where two lines indicate one or more connections between devices. For instance, double-lined path 422 may indicate that there are one or more connections between one or more host devices included within aggregate host representation 426 (or within a further aggregate host representation within aggregate host representation 426) and one or more of the switch devices included within aggregate switch representation 428. Further, double-lined path 424 may indicate that there are two or more connections between one or more storage devices included within aggregate storage representation 430 (or within a further aggregate storage representation within aggregate storage representation 430) and the switch device represented by switch device representation 432.

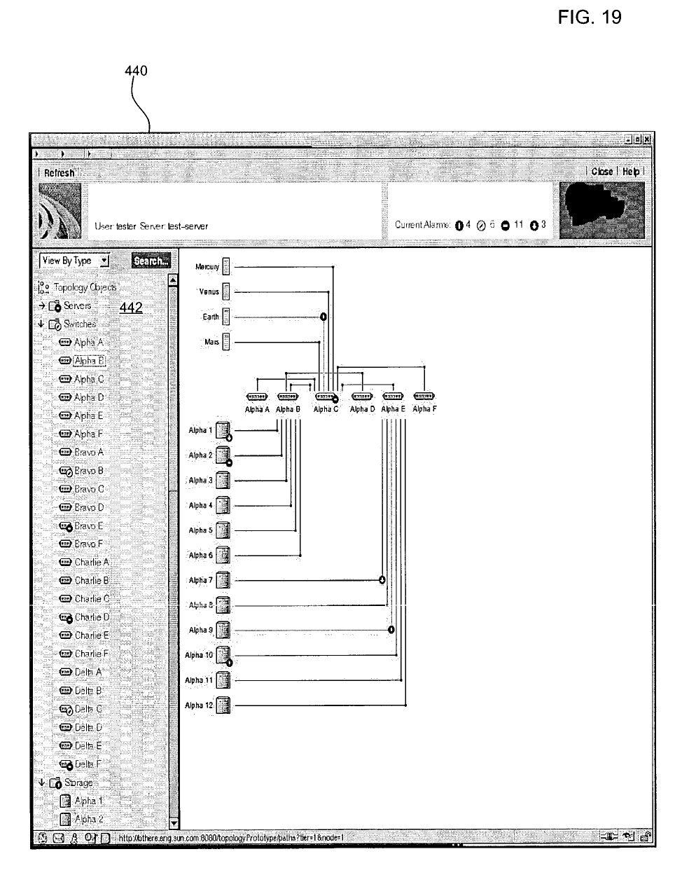

FIG. 19 illustrates a further implementation of a user interface 440 having a device selection panel 442. Upon the user selecting one of the displayed devices, such as switch “Alpha B” as displayed, all the connections and status from the switch “Alpha B” is displayed. The implementation of FIG. 19 provides the option to select specific devices to display status for a selected device. Panel 442 provides an alternative visualization of the devices in the system.

In additional implementations, the user may cause the display of a menu or dialog box to enable the user to add or remove devices or aggregations of devices from a current selected aggregate device representation, or rename an aggregate device representation. The menu may also be used to invoke diagnostic operations with respect to any devices rendered in the topology or the connections between devices. FIG. 18 provides an example of a menu item 432 that when selected renders a menu in which the user may select various menu options for additional operations. The menu may also be displayed by right clicking an item, or performing any other user interface operation for invoking a menu known in the art. For instance, in one implementation, the user may use an input device, such as a mouse, to direct a displayed pointer over a displayed aggregate device representation and right click to cause the display of a menu to enable modifying the devices and aggregate device representations included within the aggregate device representation being modified.

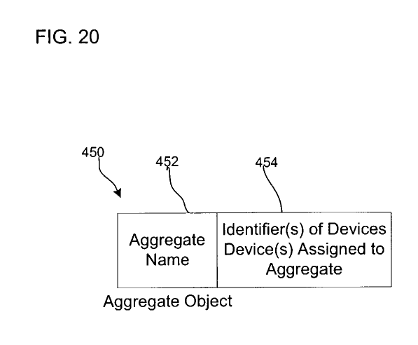

FIG. 20 illustrates an example of a data structure 450 used by the topology engine 36 to maintain information of aggregations that aggregate one or more devices or further aggregations. For each created aggregate, the topology engine 36 maintains an aggregate object 450 that provides a name or identifier of the aggregate 452 and a device identifier 454 for each device (e.g., switch, host, storage device, etc.) assigned to that aggregate. The device identifiers 454 may comprise an identifier that is used to identify the device in the graph topology 44 (FIG. 2) or associate the device assigned to the aggregate object 450 with information on the device in the graph topology 44, which indicates the connections between the device and other devices in the network. The aggregate object 450 may comprise any data structure known in the art, such as a record in a database, file, information within a file, separate data object, etc.

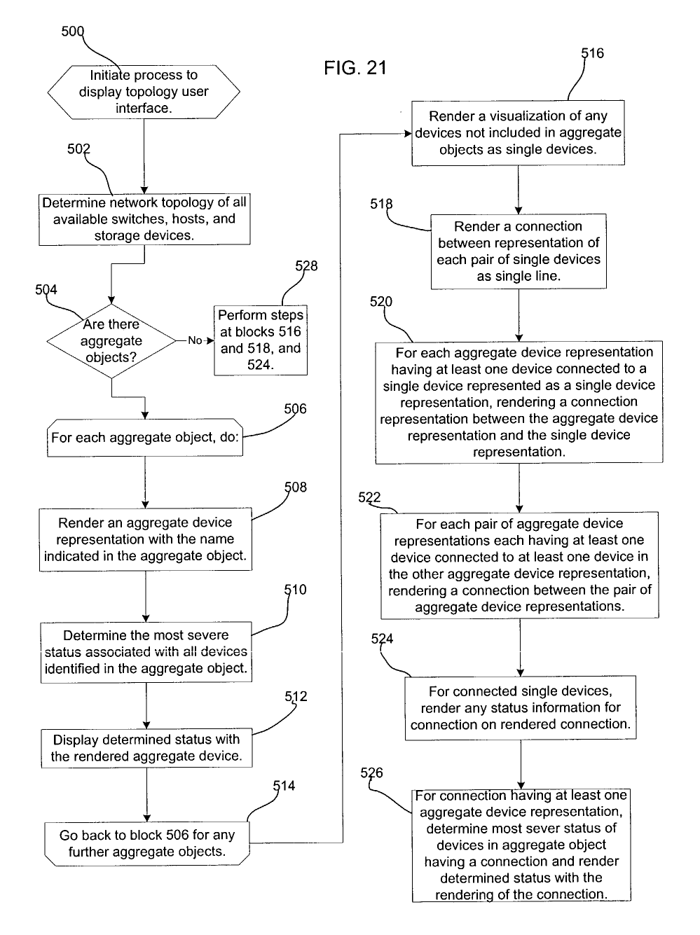

FIG. 21 illustrates logic implemented in the graph engine 36 to generate a topology visualization that includes aggregate device representations as shown above. Upon initiating the process to render a topology visualization (at block 500), the topology engine 36 determines (at block 502) the network topology, including all available hosts, storage devices, switches and connections therebetween. The topology engine 36 may utilize the logic described in the copending and commonly assigned patent application entitled “Method, System, and Program for Rendering a Visualization of Network Devices,” having U.S. application Ser. No. 10/290,868, which application was incorporated herein by reference in its entirety above, to determine the network topology. If (at block 504) there are aggregate objects 450 (FIG. 20) maintained for the topology, then a loop is performed at blocks 506 through 514 for each aggregate object 450. At block 508, the topology engine 36 renders an aggregate device representation with the name 452 indicated in the aggregate object, such as shown in FIGS. 14-18. The topology engine 36 further determines (at block 510) the most severe status associated with all devices identified in aggregate object identifiers 454 and displays (at block 512) the determined most severe status with the rendered aggregate device. Control then returns (at block 514) back to block 506 if there are further aggregate objects to process.

The topology engine 36 further renders (at block 516) a visualization of single devices in the graph topology 44 not included in any aggregate objects 450. A connection is rendered (at block 518) between representations of each pair of connected single devices. The rendered connection may comprise a single line or other connection representation. For each aggregate device representation having at least one device connected to a single device represented as a single device representation, the topology engine 36 renders (at block 520) a connection representation between the aggregate device representation and the single device representation. For each pair of aggregate device representations each having at least one device connected to at least one device in the other aggregate device representation, a connection is rendered (at block 522) between the pair of aggregate device representations. The topology engine 36 renders (at block 524) status information on a connection between each pair of connected single devices. For each connection including at least one aggregate device representation, the topology engine 36 determines (at block 526) the most severe status of devices in the aggregate object having a connection to another device and renders the determined status with the rendering of the connection.

In certain implementations, the connections between representations of single devices and aggregate device representations may be rendered as lines forming right angles, such as shown in FIGS. 14-18. Further, at each right angle a status box may be rendered providing information on the connection to visualize status information on a connection in the manner described above. In the described implementations, the connection representation comprises a single line. In additional implementations, the connection representation may be rendered as multiple lines. For instance, multiple lines extending between one aggregate device representation and one single device representation or aggregate device representation may indicate multiple connections therebetween.

The described implementations for rendering a topology visualization provide user interfaces that allow numerous devices and connections to be rendered in the user interface in a compact and concise manner. Further, described implementations provide visualizations of status information on devices and connections in the topology in a manner that minimizes clutter and distractions in the visualization.

The described techniques for enabling a user to specify configuration and allocation strategies for allocating storage may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks,, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code in which preferred embodiments are implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Thus, the “article of manufacture” may comprise the medium in which the code is embodied. Additionally, the “article of manufacture” may comprise a combination of hardware and software components in which the code is embodied, processed, and executed. Of course, those skilled in the art will recognize that many modifications may be made to this configuration without departing from the scope of the present invention, and that the article of manufacture may comprise any information bearing medium known in the art.

The described implementations discussed maintaining information on components within a SAN. However, those skilled in the art will appreciate that the device management techniques described herein may be utilized to maintain information on components within any network environment known in the art.

The described implementations provided a topology and object architecture for maintaining information on different components in a SAN network. An alternative object architecture may be provided, such that component information described as included in different objects may be merged in a single object or component information described as included in a single object may be distributed across multiple objects.

The illustrated logic of FIGS. 13 and 21 shows certain events occurring in a certain order. In alternative implementations, certain operations may be performed in a different order, modified or removed. Moreover, steps may be added to the above described logic and still conform to the described implementations. Further, operations described herein may occur sequentially or certain operations may be processed in parallel. Yet further, operations may be performed by a single processing unit or by distributed processing units.

In described implementations, devices connected to a same device or group of devices were grouped within an aggregate device representation. In alternative implementations, a user may select how devices are grouped within an aggregate device representations. Users may group devices within an aggregate device representation based on business or any other criteria, i.e., all devices within a particular facility, used by a particular group within the organization, etc.

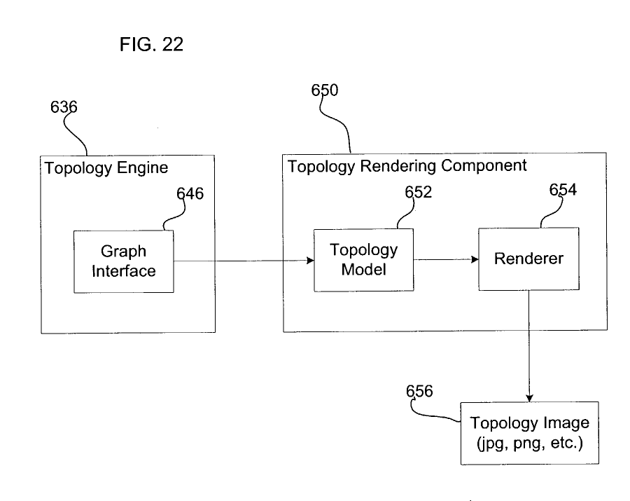

FIG. 22 illustrates an alternative implementation of the graph engine 36 shown in FIG. 2 for rendering the visualization of the topology. In such additional implementations, a topology engine 636 makes available a graph interface 646 that provides topological information about the network. The graph interface 646 provides the topology information to a topology rendering component 650. A topology model component 652 processes the topology information received from the graph interface 46 and extracts the relevant information needed to render the image. This extracted information needed to render the image is then transferred to the renderer component 654 which generates a topology image coded in a format capable of being visualized by an output device, such as Joint Photographs Experts Group (JPEG), a bitmap image (.BMP), Tagged Image File Format (TIFF) Portable Network Graphics (PNG), etc.

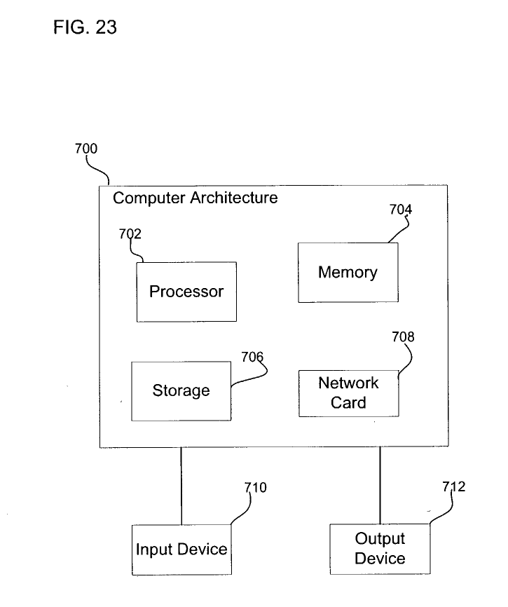

FIG. 23 illustrates one implementation of a computer architecture 700 of the SAN components and systems shown in FIGS. 1 and 2. The architecture 700 may include a processor 702 (e.g., a microprocessor), a memory 704 (e.g., a volatile memory device), and storage 706 (e.g., a non-volatile storage, such as magnetic disk drives, optical disk drives, a tape drive, etc.). The storage 706 may comprise an internal storage device or an attached or network accessible storage. Programs in the storage 706 are loaded into the memory 704 and executed by the processor 702 in a manner known in the art. The architecture further includes a network card 708 to enable communication with a network. An input device 710 is used to provide user input to the processor 702, and may include a keyboard, mouse, pen-stylus, microphone, touch sensitive display screen, or any other activation or input mechanism known in the art. An output device 712 is capable of rendering information transmitted from the processor 702, or other component, such as a display monitor, printer, storage, etc.

In the user interface implementations described herein, the visualized devices were described as being switches, hosts, and storage devices. In alternative implementations, the visualized devices and connections may comprise any type of computing device or network appliance known in the art, and is not limited to switches, hosts and storage devices. Further multiple of the rendered devices themselves may be nodes or processing complexes within a single enclosure.

Further, in the described implementations, the connections were described as comprising physical connections between devices. In alternative implementations, the connections may comprise logical paths between devices implemented in one or more physical devices. Still further, certain device representations may not be shown connected to another device representation, indicating that such represented device is not connected to another device in the network.

In the user interface implementations, devices and the connections therebetween were illustrated using certain representations of the devices and connections. In alternative implementations, any visual representation, including any image, shape, color and/or pattern, may be used to visualize the devices, connections, and status thereof.

The foregoing description of various implementations of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. An article of manufacture for rendering a visualization of a network of devices, wherein the article of manufacture causes operations to be performed, the operations comprising:
rendering aggregate device representations, wherein at least one aggregate device representation provides a single representation for a plurality of the devices;
rendering single device representations for the devices not represented by the at least one aggregate device representation; and
rendering connection representations of connections between rendered representations of the devices in the network

2. The article of manufacture of claim 1, wherein rendering connection representations further comprises:
rendering connection representations between single device representations representing connected devices; and
rendering connection representations for aggregate device representations representing at least one device connected to another device.

3. The article of manufacture of claim 2, wherein rendering connection representations for aggregate device representations further comprises:
rendering connection representations between aggregate device representations, wherein the aggregate device representation at a first end of the connection representation represents at least one device connected to at least one device represented by the aggregate device representation at a second end of the connection representation.

4. The article of manufacture of claim 3, wherein one connection representation is rendered between aggregate device representations if multiple devices included in the aggregate device representation at the first end of the connection representation are connected to multiple devices represented by the aggregate device representation at the second end.

5. The article of manufacture of claim 3, wherein connection representations extending between aggregate device representations comprise multiple lines.

6. The article of manufacture of claim 2, wherein rendering connection representations for aggregate device representations comprises:
rendering connection representations between aggregate device representations and single device representations, wherein the aggregate device representation at a first end of the connection representation represents at least one device connected to the device represented by the single device representation at a second end of the connection representation.

7. The article of manufacture of claim 2, wherein connection representations comprising multiple lines represent at least one connection from at least one device included in the aggregate device representation

8. The article of manufacture of claim 1, wherein the connection representation comprises a line extending between single and aggregate device representations that forms approximately a ninety degree angle.

9. The article of manufacture of claim 1, wherein the aggregate device representations may further represent a plurality of aggregate device representations.

10. The article of manufacture of claim 1, the operations further comprising:
receiving selection of one aggregate device representation; and
in response to receiving the selection, rendering a representation of each aggregate device representation and single device representation represented by the selected aggregate device representation.

11. The article of manufacture of claim 10, the operations further comprising:
rendering connection representations for aggregate and single device representations rendered in response to receiving user selection.

12. The article of manufacture of claim 11, wherein rendering connection representations for single and aggregate device representations rendered in response to receiving user selection further comprises:
rendering one connection representation for each single device representation rendered in response to receiving the selection that represents one single device connected to another single device; and
rendering one connection representation for each aggregate device representation rendered in response to receiving the selection that represent at least one device connected to another device.

13. The article of manufacture of claim 12, wherein rendering the connection representation comprises rendering at least one line extending from the single or aggregate device representation rendered in response to receiving the selection to the single or aggregate device representation that represents at least one device connected to one device represented by the single or aggregate device representation rendered in response to receiving the selection.

14. The article of manufacture of claim 10, wherein at least one aggregate device representation provides a single representation of at least one lower level aggregate device representation, further comprising:
in response to receiving the selection, rendering a representation of each lower level aggregate device representation represented by the selected aggregate device representation.

15. The article of manufacture of claim 1, the operations further comprising:
receiving selection to add or remove network devices and aggregate device representations to one aggregate device representation.

16. The article of manufacture of 1, the operations further comprising:
rendering a status representation for the connections represented by rendered connection representations; and
rendering status information for one connection in response to user selection of the status representation for one connection representation.

17. The article of manufacture of claim 1, wherein a first set of single and/or aggregate device representations are rendered in a substantially horizontal orientation and a second set of single and/or aggregate device representations are rendered in a substantially vertical orientation, wherein the connection representations extend between devices in the first set and devices in the second set.

18. The article of manufacture of claim 17, wherein the second set of devices comprises storage devices and host systems and wherein the first set of devices comprises switches.

19. The article of manufacture of claim 1, wherein the single device representation comprises an icon representation of the device and wherein the aggregate device representation comprises an icon showing multiple instances of the device.

20. The article of manufacture of claim 1, the operations further comprising:
rendering a status representation for each aggregate device representation, wherein the status representation comprises a status associated with at least one device represented by the aggregate device representation.

21. The article of manufacture of claim 20, wherein rendering the status information for each aggregate device representation further comprises:
determining a most severe status associated with the devices represented by the aggregate device representation, wherein the rendered status representation comprises the determined most severe status.

22. The article of manufacture of claim 20, wherein the status associated with the device comprises one of: a status indicating a state of the device or a status indicating a state of a path to which the device connects.

23. A method for rendering a visualization of a network of devices, comprising:
rendering aggregate device representations, wherein at least one aggregate device representation provides a single representation for a plurality of the devices;
rendering single device representations for the devices not represented by the at least one aggregate device representation; and
rendering connection representations of connections between rendered representations of the devices in the network.

24. The method of claim 23, wherein rendering connection representations further comprises:
rendering connection representations between single device representations representing connected devices; and
rendering connection representations for aggregate device representations representing at least one device connected to another device.

25. The method of claim 24, wherein rendering connection representations for aggregate device representations further comprises:
rendering connection representations between aggregate device representations, wherein the aggregate device representation at a first end of the connection representation represents at least one device connected to at least one device represented by the aggregate device representation at a second end of the connection representation.

26. The method of claim 25, wherein one connection representation is rendered between aggregate device representations if multiple devices included in the aggregate device representation at the first end of the connection representation are connected to multiple devices represented by the aggregate device representation at the second end.

27. The method of claim 24, wherein rendering connection representations for aggregate device representations comprises:
rendering connection representations between aggregate device representations and single device representations, wherein the aggregate device representation at a first end of the connection representation represents at least one device connected to the device represented by the single device representation at a second end of the connection representation.

28. The method of claim 23, wherein the aggregate device representations may further represent a plurality of aggregate device representations.

29. The method of claim 23, further comprising:
receiving selection of one aggregate device representation; and
in response to receiving the selection, rendering a representation of each aggregate device representation and single device represented by the selected aggregate device representation.

30. The method of claim 29, further comprising:
rendering connection representations for aggregate and single device representations rendered in response to receiving user selection.

31. The method of claim 30, wherein rendering connection representations for single and aggregate device representations rendered in response to receiving user selection further comprises:
rendering one connection representation for each single device representation rendered in response to receiving the selection that represents one single device connected to another single device; and
rendering one connection representation for each aggregate device representation rendered in response to receiving the selection that represent at least one device connected to another device.

32. The method of claim 29, wherein at least one aggregate device representation provides a single representation of at least one lower level aggregate device representation, further comprising:
in response to receiving the selection, rendering a representation of each lower level aggregate device representation represented by the selected aggregate device representation.

33. The method of claim 23, further comprising:
rendering a status representation for the connections represented by rendered connection representations; and
rendering status information for one connection in response to user selection of the status representation for one connection representation.

34. The method of claim 23, further comprising:
rendering a status representation for each aggregate device representation, wherein the status representation comprises a status associated with at least one device represented by the aggregate device representation.

35. A system for rendering a visualization of a network of devices, comprising:
means for rendering aggregate device representations, wherein at least one aggregate device representation provides a single representation for a plurality of the devices;
means for rendering single device representations for the devices not represented by the at least one aggregate device representation; and
means for rendering connection representations of connections between rendered representations of the devices in the network.

36. The system of claim 35, wherein the means for rendering connection representations further performs:
rendering connection representations between single device representations representing connected devices; and
rendering connection representations for aggregate device representations representing at least one device connected to another device.

37. The system of claim 36, wherein the means for rendering connection representations for aggregate device representations further performs:
rendering connection representations between aggregate device representations, wherein the aggregate device representation at a first end of the connection representation represents at least one device connected to at least one device represented by the aggregate device representation at a second end of the connection representation.

38. The system of claim 37, wherein one connection representation is rendered between aggregate device representations if multiple devices included in the aggregate device representation at the first end of the connection representation are connected to multiple devices represented by the aggregate device representation at the second end.

39. The system of claim 36, wherein the means for rendering connection representations for aggregate device representations further performs:
rendering connection representations between aggregate device representations and single device representations, wherein the aggregate device representation at a first end of the connection representation represents at least one device connected to the device represented by the single device representation at a second end of the connection representation.

40. The system of claim 35, wherein the aggregate device representations may further represent a plurality of aggregate device representations.

41. The system of claim 35, further comprising:
means for receiving selection of one aggregate device representation; and
means for rendering, in response to receiving the selection, a representation of each aggregate device representation and single device represented by the selected aggregate device representation.

42. The system of claim 41, further comprising:
means for rendering connection representations for aggregate and single device representations rendered in response to receiving user selection.

43. The system of claim 42, wherein the means for rendering connection representations for single and aggregate device representations rendered in response to receiving user selection further performs:
rendering one connection representation for each single device representation rendered in response to receiving the selection that represents one single device connected to another single device; and
rendering one connection representation for each aggregate device representation rendered in response to receiving the selection that represent at least one device connected to another device.

44. The system of claim 41, wherein at least one aggregate device representation provides a single representation of at least one lower level aggregate device representation, further comprising:
means for rendering, in response to receiving the selection, a representation of each lower level aggregate device representation represented by the selected aggregate device representation.

45. The system of claim 35, further comprising:
means for rendering a status representation for the connections represented by rendered connection representations; and
means for rendering status information for one connection in response to user selection of the status representation for one connection representation.

46. The system of claim 35, further comprising:
means for rendering a status representation for each aggregate device representation, wherein the status representation comprises a status associated with at least one device represented by the aggregate device representation.
